(19) United States
(12) Patent Application Publication
(10) Pub. No.: US 2015/0289542 A1
(43) Pub. Date: Oct. 15, 2015

(54) Method for Texturing Vegetable Fibres and Proteins

(71) Applicant: PROVIAND B.V., Breda (NL)

(72) Inventor: Paul den Dulk, The Hague (NL)

(21) Appl. No.: 14/646,942

(22) PCT Filed: Nov. 23, 2012
(86) PCT No.: PCT/NL2012/050835

§ 371 Date: May 22, 2015

(51) Int. Cl. A23J 3/26; A23L 1/305

(52) U.S. Cl. CPC A23J 3/26; A23L 1/3055; A23V 2002/00

(57) ABSTRACT

The present invention relates to a method for providing a meat substitute composition, comprising providing plant fibers having a water content of at least wt % and mixing with vegetable protein, followed by extruding the homogeneous dough in a co rotating twin screw extruder having intermeshing screws under addition of water, and texturing the extrudate in a container wherein the extrudate is subjected to a temperature of between 50° C. to 10 20° C. and a pressure of between 10 to 70 bar for a time period of 2 to 20 minutes, thereby providing the meat substitute composition.

The present invention relates to a method for providing a meat substitute composition. According to a further aspect the present invention relates to a meat substitute composition. Further, the present invention relates to use of a meat substitute, and to meat hybrids comprising the present meat substitute composition.

Meat substitutes, or meat analogs, are nutrition products which are rich on proteins, and therefore they could provide the recommended daily intake of proteins while the consumption of meat is avoided. Generally, fish and meat, especially muscle meat, are the main providers of proteins, which are a necessary for the human health being.

Meat substitutes are already known for centuries, as being a part of environmental, cultural and religious habitats. Common meat substitutes are based on soy such as tofu and tempeh, since soy is a readily available source of proteins. Tempeh is generally produced by fermentation of soy beans into a cake. Tofu is made by coagulating soy juice wherein the curds provided are further processed to the characteristic white blocks.

Nowadays, meat substitutes are more and more becoming close meat imitates. Not only in terms of protein content, particularly in terms of texture. Several efforts concentrated on processes to develop products providing a meat like mouth feel. An example of such a meat substitute is textured soy protein, made from soy flour or concentrate reaching high protein contents. The product is textured via an extruder which denaturizes the proteins, thereby providing a fibrous spongy matrix which closer imitates muscle meat than the earlier soy based products. However, textured soy protein as currently known is still not good enough to provide a meat like mouth feel.

In addition to the search for suitable processes, another challenge is to find the correct ingredients and recipes which provide the necessary nutrition, as well as a meat like texture and thereby perception by consumers.

Given the above disadvantages, there is a need in the art for a method for providing meat substitutes, as well as ingredients and recipes suitable to provide meat substitutes.

Therefore, the object of the present invention is, amongst other objects, to provide a method and recipe for providing meat substitutes.

This object, amongst other objects, is met by providing a method according to the appended claim 1.

Specifically, this object, amongst other objects, is met by providing a method for providing a meat substitute composition, comprising the steps of:
(i) providing plant fibers having a water content of at least 1 wt %;
(ii) mixing the plant fibers with vegetable protein, thereby providing a homogeneous dough;
(iii) extruding the homogeneous dough in a co rotating twin screw extruder having intermeshing screws under addition of water, thereby providing an extrudate having a water content of less than 60 wt % of the extrudate;
(iv) texturing the extrudate in a container wherein the extrudate is subjected to a temperature of between 50° C. to 120° C. and/or a pressure of between 10 to 70 bar for a time period of 2 to 20 minutes, thereby providing the meat substitute composition.

‘Providing plant fibers’, as used in the present context may comprise the dejuicing of plant material such as pulp, for example carrot or pea fiber, to a desired water content. Accordingly, the present plant fibers are preferably dejuiced plant fibers, however, which have not been dried. Preferably, the water content of the present plant fiber is from 1, 2, 5 or 10 to 85, preferably from about 20, 30, 40 or 50 wt % to 80, more preferably from about 60, 65, or 70 wt % to about 80 or 85 wt %. Plant fibers can advantageously be provided by processing the starting plant material with a decanter or centrifuge to separate juice from the plant material. Preferably, the plant fibers are derived from dark root vegetables, such as carrot, in order to provide meat substitutes having a dark colour. Similarly, the present plant fiber may be derived from light coloured seeds, such as peas, in order to provide chicken like meat having a light colour.

The present ‘mixing the plant fibers with vegetable protein, starch and a vegetable oil thereby providing a (substantially) homogeneous dough’ is advantageously carried out by a mixer, preferably a feed mixer, such as a vertical or a horizontal mixer.

The present ‘texturing the extrudate in a container’ comprises texturing, or tempering, of the extrudate in a cooling die. Preferably, the temperature in the present container and/or cooling die is between 50° C. to 120° C., more preferably between 70° C. to 120° C., most preferably between 90° C. to 120° C. Further, the temperature in the present container and/or cooling die may decrease from feed to exit, preferably with the temperatures ranges as indicated above. The present texturing step (iv) is advantageous for providing the desired crosslinked texture of plant fibers and vegetable protein, which closely resembles the texture of muscle meat.

Preferably, the pressure in the present container and/or cooling die varies between 10 to 70 bar, more preferably between 15 to 50 bar. More preferably, the pressure in the present container or cooling die decreases from feed to exit, preferably with the pressure ranges indicated, such as from 70 or 50 and the feed to 10 or 15 bar at the exit.

Preferably, the time period of step (iv) wherein the present extrudate is subjected to heat and/or pressure is between 1, 2, 3, to 20 or to 10 minutes. Such as for about 4, 5, 6, 7, 8, 9, 10, 11, 12, 13, 14 or about 15 minutes.

In a preferred embodiment, the present homogenous dough comprises starch and/or a vegetable oil. Preferably, the vegetable oil is sunflower oil. Alternatively, the present vegetable oil is derived from rapeseed, canola, peanut, corn, palm, avocado, walnut, brassica and linseed oil.

The term ‘extrudate’ as used in the present context means the product which is textured, or processed, by the extruder.

Preferably, the present extrudate having a water content of less than 60 wt % of the extrudate, has a water content of less than 50 or 49 wt % of the extrudate, more preferably a water content of 40 to 45 or 50 wt % of the extrudate.

Preferably, the present extruding, or texturing step (iii) comprises heating the ingredients while extruding until around 170° C. and/or wherein the extrudate leaving the present extruder has a temperature of around 120° C.

The present inventors found that by the method according to the present invention, a meat substitute can be obtained which is completely vegetable based, which provides the necessary nutrition, which meat substitute has structure which closely imitates meat and has a meat like mouth feeling. Especially in comparison with muscle meat, the present meat substitute exhibits a similar tenderness and requires approximately the same number of chews before it can be swallowed down.

Without being bound to theory, it is to be understood that using wet plant fibers instead of dry plant fibers, for example plant fibers having a water content below 85 wt %, the fiber structure of the plant fibers remains intact and exhibit improved crosslinking with the present plant protein. The present inventors found that wet plant fibers exhibit an improved crosslinking with plant proteins, thereby providing improved meat substitute compositions.

According to a preferred embodiment of the present method, the present homogeneous dough comprises around 30, or 40, to around 60 wt % vegetable protein and/or around 25 to around 40 wt % plant fibers, preferably plant fiber having a water content of about 60, 65, or 70 wt % to about 80 or 85 wt %. The products obtained by the present embodiment provide an excellent crosslinking between vegetable protein and plant fibers, thereby obtaining a meat substitute having an improved meat like tenderness.

In yet a further embodiment, the present homogeneous dough comprises 45 to 55 wt % vegetable protein and/or 25 to 35 wt % plant fibers, preferably plant fiber having a water content of about 60, 65, or 70 wt % to about 80 or 85 wt %.

According to a further preferred embodiment, the present plant fibers comprise, or are, carrot fibers. Carrot fibers are advantageously used due to their plant fiber structure. Additionally, using carrot fibers is useful in the production of red meat substitutes due to the dark, or dark orange, colour.

In another preferred embodiment, the present plant protein is a pea protein, such as pea protein isolates extracted from the yellow pea, which is a natural and gluten free starting material. Preferably, the dry matter content of the present pea protein is approximately 95%. Preferably, the present plant protein is not amaranth or amaranth flour.

According to a preferred embodiment of the method of the invention, the present intermeshing screws have an outer diameter to inner diameter ratio from 1.5:1 to 2.5:1. More preferably from 1.6 or 1.7:1 to 2.0 or 2.5:1. The outer diameter is defined as the total diameter of the screw including thread, i.e. the forwarding and reversing paddles, and cylinder or cone. The inner diameter is defined as the diameter of the cylinder or cone. By using intermeshing screws having the indicated ratio, the screw volume is very high. This provides an efficient and industrial scale production of present meat substitute, while remaining its unique quality in terms of structure and tenderness.

According to a further improved embodiment, the present step (iii) comprises extruding the homogenous dough with a velocity of at least 1000 RPM. More preferably with at least 1200 or 1300. Most preferably at least 1400 RPM. ‘RPM’ as used in the present context means revs per minute.

Given the above advantageous properties of the meat substitute provided by the present method, the present invention relates, according to a further aspect, to the meat substitute composition obtainable by the present method. Advantageously, this meat substitute obtainable by has a water content of less than 50 wt %.

According to a further aspect, the present invention relates to a meat substitute composition, comprising starch, 20 to 40 wt % plant protein, 5, or 10 to 25 wt % plant fiber and/or 40 to 60 wt % water. This advantageous meat substitute has a structure which closely imitates meat and has a meat like mouth feeling, while it is completely vegetable based. Especially in comparison with muscle meat, the present meat substitute exhibits a similar tenderness and requires approximately the same number of chews before it can be swallowed down.

Preferably, the present meat substitute composition comprises 25 to 35 wt % plant protein, 10 to 20 wt % plant fiber and/or 40 to 55 wt % water. Meat substitutes comprised this ingredients are unique due to their tenderness. More specifically, chewing said meat substitute requires at least 6 chews before the meat substitute composition degrades.

Given the advantageous tenderness properties of the present meat substitute, the present invention relates according to another aspect, to meat hybrids comprising the present meat substitute composition. A ‘meat hybrid’ as used in the present context, is a foodstuff, or foodproduct, which both comprises meat and meat substitute. The present meat substitute composition can advantageously be used in a meat hybrid because it has excellent adhesive properties with meat. For example, meat balls comprising mince meat and the present meat substitute composition can baked and fried without disintegration and crumbling.

Given the above advantageous properties as meat substitute composition, the present invention relates according to another aspect to the use of the present meat substitute composition as a foodstuff, or as a foodproduct, such as use of the present meat substitute composition in hybrid products.

The present invention fill be further elucidated in the following non limiting examples. In the examples, reference will be made to the figures, wherein

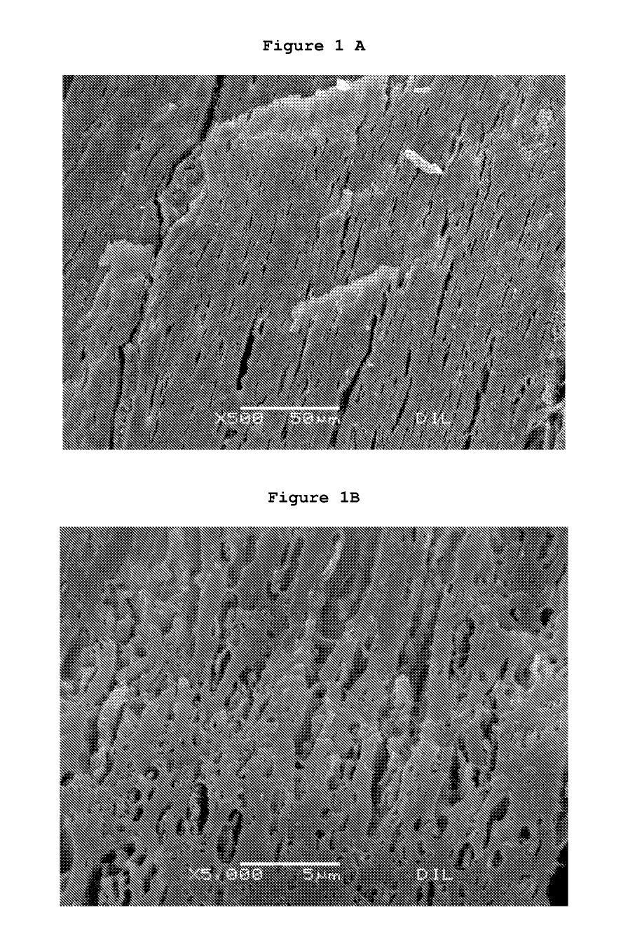

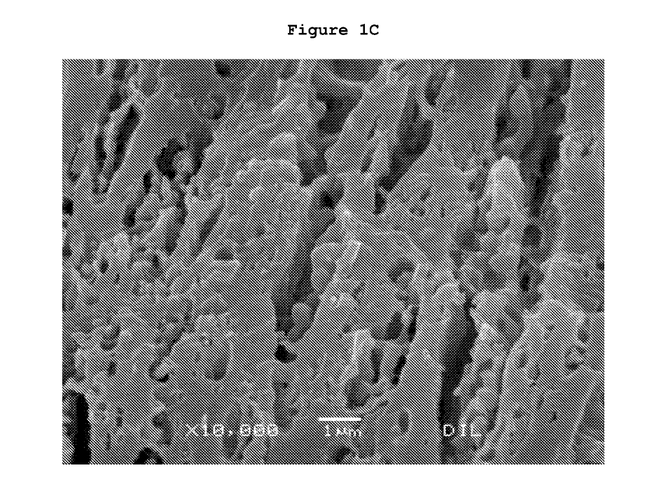

FIG. 1 shows three SEM pictures of a meat substitute composition according to the present invention, of x500, x5000 and x10000 zoom, respectively;

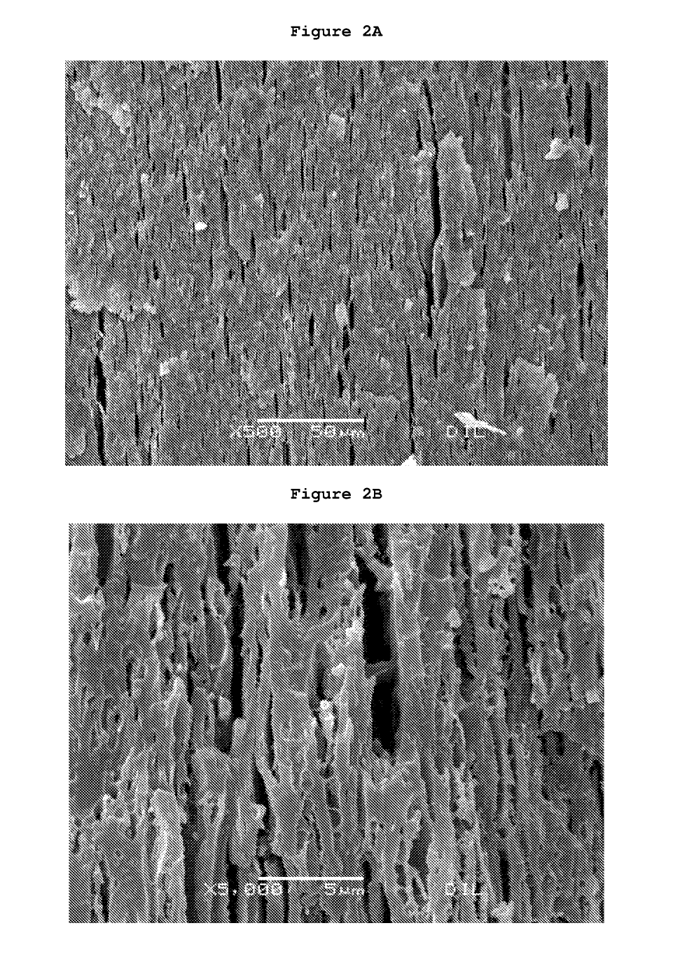

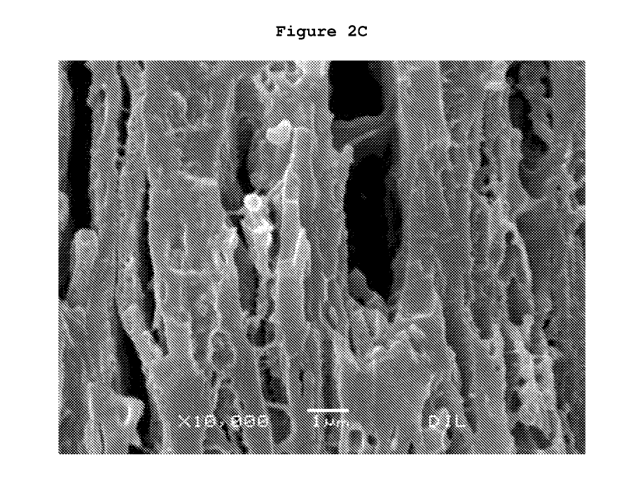

FIG. 2 shows three SEM pictures of an alternative meat composition, of x500, x5000 and x10000 zoom, respectively;

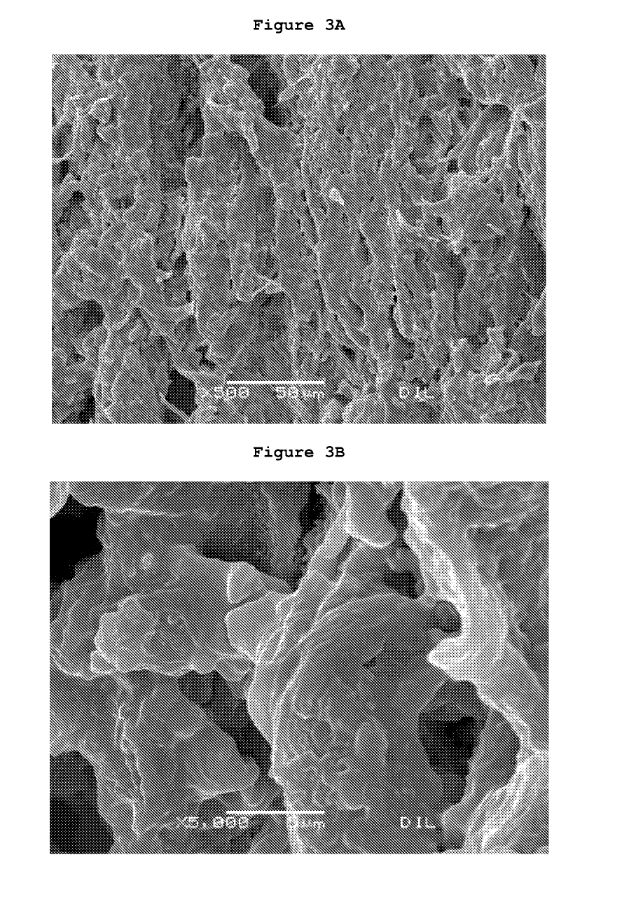

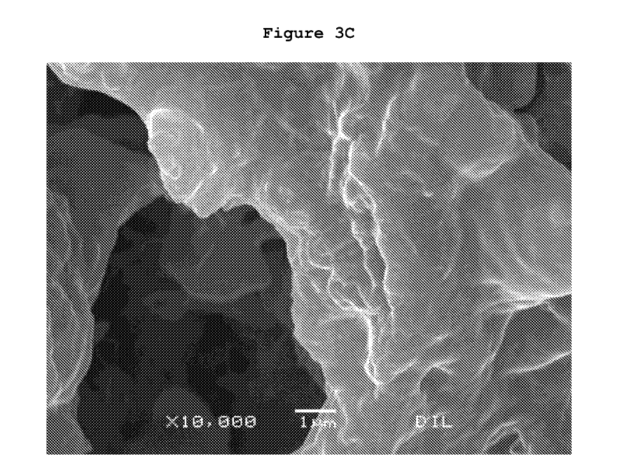

FIG. 3 shows three SEM pictures of meat substitute composition made by dry carrot fiber, of x500, x5000 and x10000 zoom, respectively;

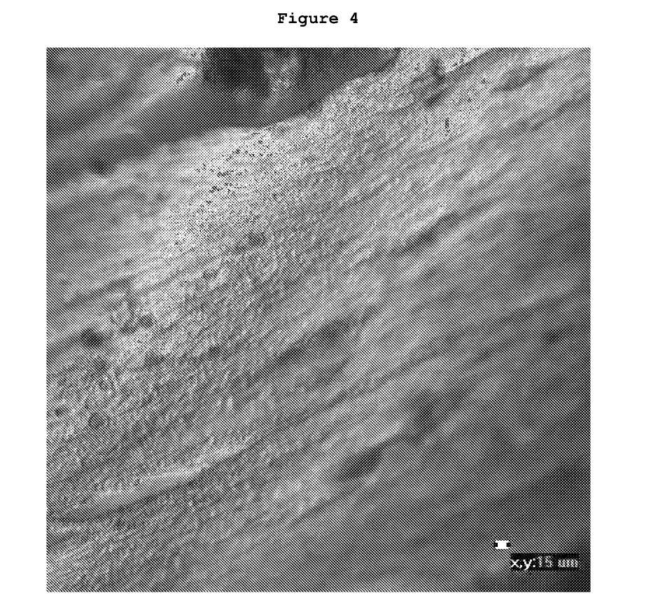

FIG. 4 shows a CLSM picture of a meat substitute composition according to the invention;

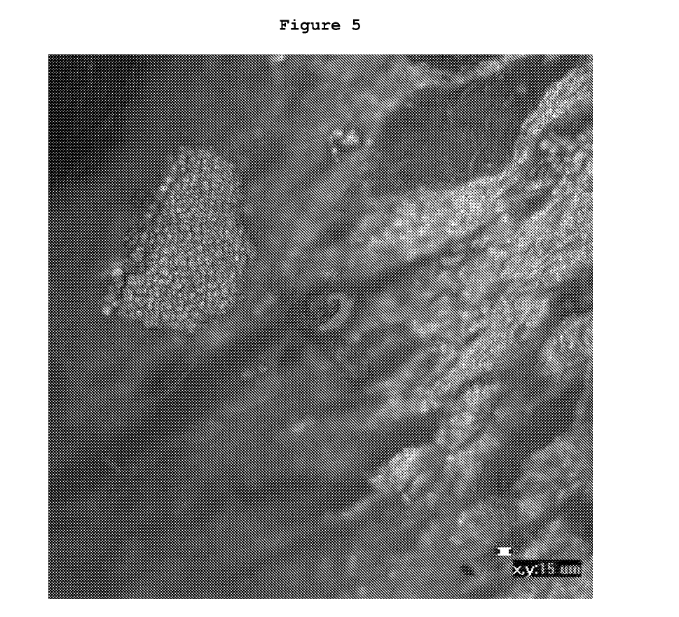

FIG. 5 shows a CLSM picture of a conventionally made meat substitute composition.

### EXAMPLES

### Example 1

### Carrot Fiber 74 wt % Water

### Ingredients

As vegetable protein pea protein were used, and as plant fiber carrot fiber having a water content of 74 wt % was used. The ratio of pea protein:carrot fiber was 3:2.

### Extrusion Process

The ingredients were mixed in a vertical mixer and subsequently fed to a Berstorff lab extruder having a capacity of 10 kg/hour. The temperature in the extruders increases from 20° C. to 170 c. The pressure in the extruder was 10 bar, the rotation speed was 400 RPM. The water inflow in the extruder varied from 2 to 4.5 liter/hour, dependent of the water content of the used plant fibers.

### Texturing Process

The extrudate having a temperature of 110° C. was fed into a cooling die by a pressure of 45 bar. The pressure decreased from 45 to 15 bar at the exit of the cooling die. The temperature in the cooling die decreased from 110° C. to 90° C. The residence time of the extrudate in the cooling die, i.e. from feed to exit, was 6 minutes.

### Results

The product obtained had a water content of 47 wt %. The product exhibits a dense structure.

### Example 2

### Pea Fiber 10 wt % Water

Example 1 is repeated, however, pea fiber having a water content of 10 wt % was used instead of carrot fiber.

### Results

The products obtained had a water content of 49 wt %. They exhibit a dense structure.

### Comparative Example 1

### Fresh Cooked Milled Carrot

In a similar process as in example 1 and 2, a meat substitute composition was provided by using the same ingredients as in example 1, however wherein carrot pulp having water content of 88 wt % was used instead of carrot fiber having a water content of 74 wt %.

### Comparative Example 2

### Dry Carrot Fiber

In a similar process as in example 1 and 2, a meat substitute composition was provided by using the same ingredients as in example 1, however wherein dry carrot fiber in powder form was used instead of carrot fiber having a water content of 74 wt %.

### Example 3

### SEM Analysis

The meat substitute compositions provided by using carrot fiber having 74 wt % water (example 1), carrot pulp having 88 wt % water (comparative example 1) and dry carrot fiber (comparative example 2), respectively, have been analyzed on their texture.

Specifically, SEM pictures were made and are depicted in FIGS. 1-3. FIG. 1 represents pictures from meat substitute provided by using carrot fiber having 74 wt % water (example 1). FIG. 2 represents pictures from meat substitute provided by using carrot pulp having 88 wt % water (comparative example 1). FIG. 3 represents pictures from meat substitute provided by using dry carrot fiber (comparative example 2).

### Results

Comparing the FIGS. 1-3, it can be clearly seen that the structure of FIGS. 1A, 1B and 1C is less open, i.e. denser than the structure of FIGS. 2A, 2B, 2C and 3A, 3B, 3C. Thus, by using carrot fibers having a water content of 74 wt % a denser matrix is obtained than by using carrot pulp or dry carrot fiber.

### Comparative Example 3

### Soy & Dry Carrot Fiber

In a similar process according to US2012/0093994, a meat substitute composition was provided by using soy protein isolate, amaranth flour, dry carrot fiber, and canola oil in 79:15:5:1 ratios.

### Example 4

### CLSM Analyses

The meat substitute compositions provided by carrot fibers having a 74 wt % water content (example 1) and dry carrot fibers in a mix with amaranth, (comparative example 3) have been analyzed with regard to their matrix.

Specifically, the meat substitute compositions were analyzed by confocal laser scanning microscopy (CLSM). FIG. 4 shows a CLSM picture of the composition according to example 1, FIG. 5 shows a CLSM picture of the composition according to comparative example 3.

In the CLSM pictures show a green continuous phase (matrix) with red fat droplets. Long small black shapes in the continuous phase are gaps/breaks in the matrix.

### Results

Comparing FIGS. 4-5, it can be clearly seen that the matrix depicted in FIG. 4 is less open, i.e. denser, than the matrix in FIG. 5. Further, the distribution of fat droplets through the matrix is more homogenous in FIG. 4 than in FIG. 5.

Accordingly, by using carrot fibers having a water content of 74 wt % a denser matrix is obtained than a matrix comprising soy protein isolate, amaranth flour, dry carrot fiber, and canola oil in 79:15:5:1 ratios.

### Example 5

### Tenderness

Steaks consisting off the meat substitute compositions of example 1, 2 and comparative examples 1 and 3 were made. Subsequently the steaks were baked in a combination of oil/butter. Specifically, 8 steaks per category were made, in total 32 steaks were tested. After cooling down, the steaks were cut into half and tested by a consumer panel consisting of 13 persons, which counted the number of chews which were necessary to disintegrate the steak.

### Results

| | Number of chews |
|---|---|
| Example | (average) |
| Example 1 | 9 |
| Example 2 | 6 |
| Comparative example 1 | 4 |
| Comparative example 3 | 2 |

### Conclusion

By using carrot fiber having a water content of 74% wt, an improved product is obtained in terms of tenderness. More specifically, the number of chews which were necessary to disintegrate the steak was on average 9, while a steak made by soy, amaranth flour, dry carrot fiber, and canola oil in 79:15:5:1 ratios, already disintegrated after 2 chews.

Further, the members of the test panel reported the steak of comparative example 3 as having a granular and liver like texture, whereas the steak according example 1 is reported as succulent. In conclusion, the texture of the meat substitute according example 1 and 2 is improved.

### Example 6

### Industrial Scale

Meat substitute composition according to example 1 and 2 have been prepared on an industrial scale.

### Extrusion Process

The ingredients were mixed and fed to a co rotating twin screw extruder having intermeshing screws, having an outer/inner diameter of 1.8. The rotational speed was 1200 RPM. During extrusion, the ingredients were heated for providing an extrudate having a temperature of 118° C.

### Texturing Process

The extrudate having a temperature of 118° C. was forced into a cooling die by a pressure of 44 bar. The extrudate remained in the cooling die for 5 minutes, wherein the temperature of the extrudate decreased towards 88° C. The pressure in the cooling die decreased from feed to exit from 44 to 15 bar.

### Results

By using the above extruder settings and texturing process, it was possible to produce meat substitute composition with 220 kg/hour, having a water content of 49 wt %. The obtained meat substitute composition had the same properties as the lab scale produced composition of example 1 and 2.

### Conclusion

By the above extruder settings, it was possible to produce the present meat substitute composition on an industrial scale.

1. Method for providing a meat substitute composition, comprising the steps of:
(i) providing plant fibers having a water content of at least 1 wt %;
(ii) mixing the plant fibers with vegetable protein, thereby providing a homogeneous dough;
(iii) extruding the homogeneous dough in a co rotating twin screw extruder having intermeshing screws under addition of water, thereby providing an extrudate having a water content of less than 60 wt % of the extrudate;
(iv) texturing the extrudate in a container wherein the extrudate is subjected to a temperature of between 50° C. to 120° C. and a pressure of between 10 to 70 bar for a time period of 2 to 20 minutes, thereby providing the meat substitute composition.

2. Method according to claim 1, wherein the plant fibers have a water content of between 1 and 85 wt %.

3. Method according to claim 1 or claim 2, wherein the plant fibers have a water content of between 70 and 85 wt %.

4. Method according to any of the claims 1 to 3, wherein the homogeneous dough comprises 30 to 60 wt % vegetable protein and 25 to 40 wt % plant fibers, preferably wherein the homogeneous dough comprises 40 to 55 wt % vegetable protein and 25 to 35 wt % plant fibers.

5. Method according to any of the claims 1 to 4, wherein the plant fibers are carrot fibers.

6. Method according to any of the claims 1 to 5, wherein the vegetable protein is pea protein.

7. Method according to any of the claims 1 to 6, wherein the intermeshing screws have an outer diameter to inner diameter ratio from 1.5:1 to 2.5:1.

8. Method according to any of the claims 1 to 7, wherein step (iii) comprises extruding the homogenous dough with at least 1000 RPM.

9. Meat substitute composition obtainable by the method according to any of the claims 1 to 8.

10. Meat substitute composition, comprising 20 to 40 wt % plant protein, 10 to 25 wt % plant fiber and 40 to 60 wt % water.

11. Meat substitute composition according to claim 10, wherein the plant protein is pea protein and/or wherein the plant fiber is carrot fiber.

12. Meat hybrid comprising the meat substitute composition according to any of the claims 9 to 11.

13. Use of a meat substitute according to any of the claims 9 to 11 as a foodstuff.
